(19) United States
(12) Patent Application Publication
(10) Pub. No.: US 2006/0081305 A1
(43) Pub. Date: Apr. 20, 2006

(54) Machine for filling containers with liquid products

(75) Inventor: Giuseppe Monti, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: Marchesini Group S.P.A., Pianoro (IT)

(21) Appl. No.: 11/248,470

(22) Filed: Oct. 11, 2005

(30) Foreign Application Priority Data
Oct. 14, 2004 (IT) BO2004A 000630

(51) Int. Cl. B67C 3/00

(52) U.S. Cl. 141/144

(57) ABSTRACT

A machine for continuous filling containers with liquid products has a rotating carrousel with a tank containing a liquid product to be delivered. The tank is arranged coaxial and integral with the carrousel. A delivering element is alternately fed by the tank to deliver a batched quantity of the liquid product to a container. The delivering element is situated at the edge of the carrousel and includes substantially a piston axially sliding inside a cylinder. The cylinder has a suction aperture, set in communication with a feeding channel, which connects, in suitable step relation, the tank with the delivering element, and a delivery aperture, set in communication with a delivery channel, which connects in suitable step relation, the delivering element to the container. The delivering element shifts the connection of the cylinder to the feeding channel or to the delivery channel, to perform respective delivery or suction steps of the product. The delivering element includes also means for coupling to the carrousel, which can be rapidly dismantled.

### FIELD OF THE INVENTION

The present invention relates to a rotating machine for filling containers with liquid products.

### DESCRIPTION OF THE PRIOR ART

It is known that containers, e.g. bottles for pharmaceutical or cosmetic products and the like, are filled by automatic machines, usually rotating, which first batch the filling product and then distribute it into respective containers. The containers are supplied orderly to a line for feeding empty containers.

For example, the Patent No. EP 0 486 438 describes a rotating machine, working continuously, which substantially includes a carrousel, rotating on a vertical axis and carrying a fixed tank for products.

The carrousel carries also, along its border, a plurality of volumetric batching members, each of which includes substantially a cylinder, inside which a piston slides axially.

The piston, translating alternately, sucks and the delivers a batched quantity of product through the only aperture of the cylinder.

The machine must include a separated valve element to set the aperture in communication with the tank or with the product delivering nozzles.

The valve element is hermetically fastened to the aperture and is aimed at switching the connection alternately to a respective delivery channel and to a suction channel.

More precisely, the valve element is operated to rotate between two alternate connection positions.

This type of machine and other similar thereto, are very complicated to assemble and especially to disassemble, because they include many elements, which are difficult to access and verify.

This disadvantage affects particularly the production efficiency of the machines, because each change of product requires long stops for cleaning the elements contaminated by the product used previously.

The disassembling of the machine elements to be sterilized, and their subsequent mounting onto the machine after the sterilization, cause high costs (machine downtimes, manpower, etc.), which are difficult to be accepted.

The disassembling of the machine elements, and their immediate substitution with other, identical and previously sterilized elements, does not resolve the above mentioned problem.

At present, the elements are cleaned with one or more sterilization cycles, using for each cycle a suitable sterilizing agent, introduced into the machine circuit, occupied by the product.

This procedure does not assure that each area of the machine circuit is efficiently sterilized.

The Patent WO 01/85594 describes a machine, which uses a particular sterilizing circuit for cleaning cycles, which makes a suitable sterilizing liquid circulate through all the contaminated elements, each time a filling cycle with new liquid product is programmed.

However, also this solution, like the previous one, does not assure the complete cleaning of the contaminated elements, which are particularly difficult to examine.

Moreover, using both known, described above solutions incurs the risk to introduce undesired traces of sterilizing liquid, not only of the product delivered previously, into the containers to fill during the subsequent production cycles.

Therefore, it is not possible to use this type of machines, when high purity and sterility degrees of the packaged product are required, as for example in pharmaceutical or food fields.

### SUMMARY OF THE INVENTION

The object of the present invention is to resolve the above mentioned problem, by proposing a machine for continuous filling liquid products, which works in a reliable and sure way, and which in particular makes efficient and easy the sterilization of all the elements contaminated by the used product.

Another object of the present invention is to propose a machine for continuous filling liquid products, whose concept is simple, working surely reliable and the use versatile.

The above mentioned objects are obtained in accordance with the contents of the claims.

### BRIEF DESCRIPTION OF THE DRAWINGS

The characteristic features of the invention will be pointed out in the following, with particular reference to the enclosed figures, in which:

FIG. 1 is a perspective view of the machine proposed by the invention;

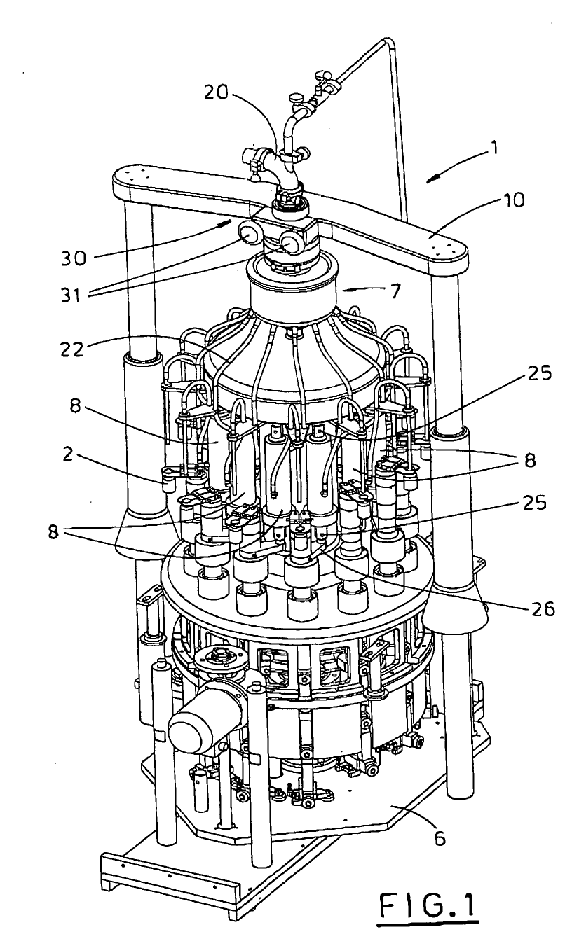

FIG. 2 is a longitudinal section view of the same machine;

FIGS. 3a and 3b are perspective, partially sectional views of a delivering member, connected to the proposed machine, respectively in steps of delivery and suction of the liquid product.

### DISCLOSURE OF THE PREFERRED EMBODIMENT

With regards to the above Figures, the reference numeral 1 indicates the whole machine for filling containers 2 with liquid products 3.

The machine 1 includes a carrousel 4, rotating on a respective vertical shaft 5, carried by a frame 6, connected to the machine stationary framework 10.

The carrousel 4, which is driven into rotation by known, not shown means, carries, in its upper part, a tank 7, aimed at containing the product 3 to deliver, and a plurality of batching members 8, distributed angularly along the carrousel 4 border.

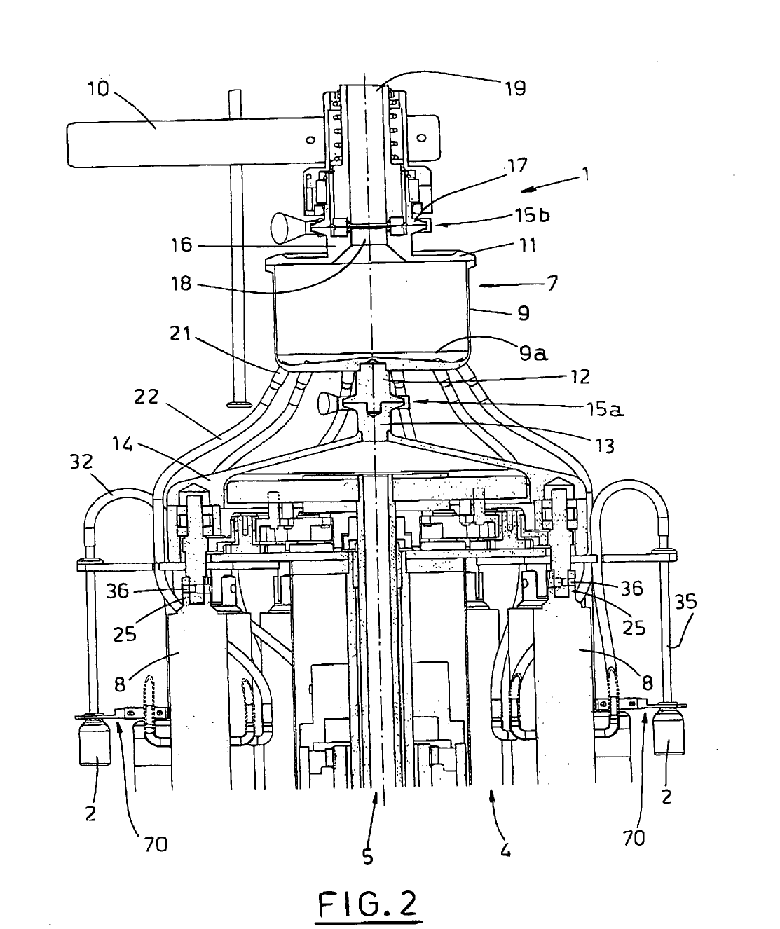

The tank 7 is situated coaxial with the shaft 5 and forms a collector 9, covered by a lid 11 (see FIG. 2).

More precisely, the lower part of the tank 7 is carried by a flange support 12, coupled with a respective flange joint 13, carried coaxial by the outer frame 14 of the carrousel 4.

Advantageously, the joining between the flange support 12 and the flange joint 13 is clasped by a quick connection means 15a, e.g. of the type known by its commercial name TRI-CLAMP.

Likewise, the upper part of the lid 11 forms a first flange element 16, defining an axial channel, which is coupled by quick connection means 15b, e.g. of the type known by its commercial name TRI-CLAMP, to a second flange element 17, connected with possibility of rotation, to the machine stationary framework 10.

More precisely, the second flange element 17 is put, by rolling means 18, on a sleeve 19, fastened to the stationary framework 10.

In practice, the product 3, coming from a fixed channel 20, flows first through the sleeve 19, introduced into the second flange element 17, then through the first flange element 16, up to the tank 7.

Screw fastening means 30 fasten stably the sleeve 19 to the stationary framework 10.

The fastening means include advantageously knob gripping means 31 for facilitating the tightening and releasing operations.

The collector 9 includes also a plurality of through holes, situated at the bottom 9a and aimed at allowing respective connectors 21 to be tightly introduced therein, for the rapid coupling to as many feeding channels 22.

In practice, the feeding channels 22 are aimed at transporting the product 3 from the tank 7 to the delivering means 8, situated below (see FIG. 2).

Each of the delivery means 8 is preferably of volumetric type and, in particular, includes a cylinder 23, arranged vertically, and a piston 24, introduced with possibility of sliding axially thereinside.

In particular, the piston 24 translates alternately between a lowered position and a raised position, where it defines, in the inner cavity 23a of the cylinder 23, a main chamber 29 of respectively minimum and maximum volume.

Each of the delivering means 8 has also means for quick connection to the carrousel 4, including preferably a pair of fork joints, connected respectively to the cylinder 23 and to the piston 24, aimed at being coupled, by pins 36, to respective hooks 26, connected to the carrousel 4 (see FIG. 2).

The cylinder 23 and the piston 24 are also aimed at rotating axially in relative motion.

In the shown case, the cylinder 23 is motionless, while the piston 24 is rotated axially, by power means of known type, not shown.

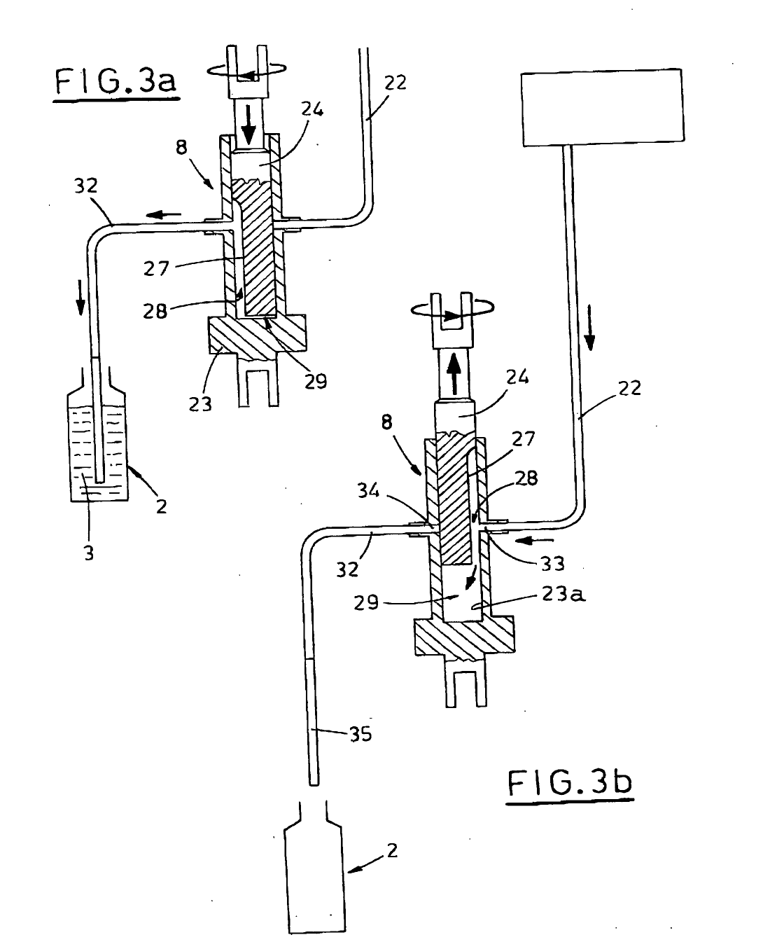

In practice, in the shown example, the piston 24 is aimed at rotating alternately between an initial angular position and a position rotated by 180° (see FIGS. 3a and 3b).

Moreover, the piston 24 has a longitudinal flat surface 27, aimed at defining a secondary chamber 28 inside the cylinder 23, meeting with the main chamber 29.

The cylinder 23, in turn, has a pair of opposite apertures 33, 34, situated in the longitudinal walls to be set in communication with respective channels 22, 32.

In particular, a suction aperture 33 is set in communication with the end of the feeding channel 22, and a delivery aperture 34 is set in communication with an end of the delivery channel 32.

The opposite end of the delivery channel 32 has a batching nozzle 35, arranged preferably vertically and aimed at delivering the product 3 into the container 2, carried by the carrousel 4 by known gripping means 70.

It is to be pointed out that when the piston 24 is in the lowered position, the top of the secondary chamber 28, defined by the longitudinal flat surface 27, communicates with one of the respective apertures 33, 34, during the delivery, as well as in the suction step.

This practically allows to set the main chamber 29 into communication with the feeding channel 22, or otherwise, with the delivery channel 32, which depends on the position of the longitudinal flat surface 27 of the piston 24, if it is in the angular position facing respectively the suction aperture 33 or the delivery aperture 34 (see again FIGS. 3a and 3b).

The operation of the machine for continuous filling of containers with liquid products will be described in the following.

In the initial step of the filling cycle, the container 2 is fed to the carrousel 4 by a feeding line.

Then, the carrousel 4 withdraws the container 2 by respective gripping means, aimed at raising it until the batching nozzle 35 is allowed to enter the container 2.

In this initial step, the piston 24 is in the lowered configuration with the longitudinal flat surface 27 facing the suction aperture 33.

In the same configuration, the wall opposite to the flat surface 27 is aimed at closing the delivery aperture 34.

Afterwards, the cylinder 23 is operated to go down, to suck the product 3 inside the main chamber 29 of the cylinder 23.

In practice, the suction occurs by transferring the product 3 from the tank 7 through the feeding channel 22, until the cylinder 23 reaches the lowered configuration.

When a batched quantity of the product 3 has been sucked, the piston 24 is rotated by 180°, in order to place the longitudinal flat surface 27 in front of the delivery aperture 34 and to close contemporarily the suction aperture 33.

Afterwards, the cylinder 23 is raised to transfer the batched quantity of product 3, collected essentially in the main chamber 29, through the delivery channel 32 to the container 2.

The delivery step is completed, when the cylinder 23 reaches the raised position.

Then, the container 2, filled with the batched quantity of product 3, is lowered and transferred to a discharge station, by the carrousel 4.

The machine for continuous filling containers with liquid products obtains the object to work in a reliable and sure way.

This result is obtained chiefly by the presence of the delivering means 8, which precisely batch and deliver batched quantities of product 3 to the containers 2.

Actually, the batched quantity is first wholly collected inside the volume defined by the main chamber 29 and by the secondary chamber 28 and then, it is transferred into the container 2 without the possibility of lacks or errors.

The object of the machine proposed by the present invention is to clean all the elements, which have touched the product 3 in a completely sure way, when the product is changed.

In particular, the above elements are sterilized in an autoclave, without damaging the production efficiency with long downtimes.

Actually, unlike the known machines, the elements in contact with the passing product 3, can be easily dismantled and transferred to a sterilization station.

The spare elements, already sterilized, can be likewise easily and rapidly mounted, to substitute the previous ones.

If it appears more economical, it is possible to substitute the disposable materials, such as the feeding channels 22 and delivery channels 32, with new elements.

These materials, in particular, are removed easily from the connectors 21 on the bottom 9a of the collector 9, or from the connections in correspondence to the apertures 33 and 34.

The tank 7 is dismantled by simply releasing the fastening means 30 by the knobs 31 and releasing the quick connection means 15 from the lid 11 and the collector 9.

It is likewise immediate to dismantle the delivering means 8, by removing the pins 36, coupling the fork joints 25, made at the end of the piston 24 of the cylinder 23.

The particular conformation of the delivering means 8 makes their sterilization in the autoclave easier; it is to be recalled that the cylinder 23 and the piston 24 can be uncoupled easily and rapidly.

Finally, the proposed machine gives the certainty that all the elements, which will subsequently get in contact with the product, are sterilized.

A particular advantage derives from the fact that, unlike the known machines, the proposed machine does not need separated valve means, which increase the machine complexity and makes the dismantling operation more difficult.

Actually, the same delivering means 8 performs the shift between the suction and delivery steps, by a simple rotation of the piston 24, having the above described longitudinal flat surface 27.

The simplicity of this operation is a further assurance of the reliability of the batching and delivery steps, not only of the perfect cleaning.

A further advantage of the invention results from the constructive simplicity of the proposed machine, which includes mechanical elements easily available and used.

It is understood that what above, has been described as a mere, not limiting example. Therefore, it is obvious that any constructive variants applied thereto remain within the protective scope of the present technical solution, as described above and claimed below.

What is claimed is:

1. A machine for filling containers with liquid products, including
a carrousel, rotating on a vertical axis of a stationary framework;
a tank, containing the liquid product to be delivered, and arranged coaxial and integral with said carrousel;
at least one delivering element alternately fed by said tank and delivering a batched quantity of said liquid product to a container, said delivering element being situated at an edge of the carrousel and including substantially a piston sliding axially inside a cylinder, with said cylinder having a first aperture, set in communication with a feeding channel for connecting said tank with said delivering element, and a second aperture, set in communication with a delivery channel for connecting said delivering element to said container, so as to shift connection of said cylinder with said feeding channel or with said delivery channel, to perform respective delivery or suction steps of said product;
coupling means for quick mounting and dismantling of said delivering element to and from said carrousel;
quick connection means for quick mounting and dismantling of said tank to and from said carrousel.

2. The machine of claim 1, wherein said means for coupling said delivering element to said carrousel include a pair of fork coupling members, situated respectively at the base of said cylinder and at top of said piston, and coupled rapidly to said carrousel by suitable joining means.

3. The machine of claim 1, wherein said tank includes substantially a collector, whose upper part is closed by a lid.

4. The machine of claim 3, wherein the lower part of said collector of the tank is supported by a flange support coupled with a respective flange joint carried by the frame of said carrousel, by said rapid coupling means.

5. The machine of claim 3, wherein the upper part of said lid of the tank carries a first flange element, coupled, by said coupling means to a second flange element connected rotatingly to the machine stationary framework.

6. The machine of claim 5, wherein said second flange element is coupled, by suitable rolling means, to a sleeve, which is fastened to said stationary framework by screw fastening means, having knob gripping means.

7. The machine of claim 1, wherein said feeding channel, preferably of flexible material, is situated, freely accessible, in a periphery area of said carrousel and is connected respectively to said tank and said cylinder of the delivery element by respective outer connectors.

8. The machine of claim 1, wherein said channel delivering the product to said container, preferably of flexible material, is situated, freely accessible, outside said delivering element and is connected respectively to said cylinder of the delivering element and to said container, by respective outer connectors.

9. The machine of claim 5, further including screw means for stable connection of the sleeve to the machine stationary framework.

10. The machine of claim 9, wherein said screw means have knob gripping means for facilitating tightening and releasing operations.
